(19) United States
(12) Patent Application Publication
(10) Pub. No.: US 2023/0394299 A1
(43) Pub. Date: Dec. 7, 2023

(54) METHOD, COMPUTING DEVICE AND COMPUTER-READABLE MEDIUM FOR CLASSIFICATION OF ENCRYPTED DATA USING DEEP LEARNING MODEL

(71) Applicants: Kongju National University Industry-University Cooperation Foundation, Gongju-si (KR); Daegu Gyeongbuk Institute of Science and Technology, Daegu (KR)

(72) Inventors: Changho Seo, Daejeon (KR); Inkyu Moon, Daegu (KR); Hyunil Kim, Daejeon (KR); Ongee Jeong, Daegu (KR)

(21) Appl. No.: 17/945,004

(22) Filed: Sep. 14, 2022

(30) Foreign Application Priority Data
Jun. 3, 2022 (KR) 10-2022-0067974

(51) Int. Cl. G06N 3/08

(52) U.S. Cl. CPC G06N 3/08

(57) ABSTRACT

The present invention relates to a method, a computing device, and a computer-readable medium for classifying encrypted data using a deep learning model, and more specifically, to a method, a computing device, and a computer-readable medium, in which original data is modified such that the original data is used as training data in a deep learning-based inference model, and the original data and the modified data are encrypted through an optical-based encryption method, so that the encrypted data is input into the inference model, and the encrypted data is labeled with any one classification item among classification items for classifying the encrypted data, thereby performing the labeling task with encrypted data itself without the process of decrypting the encrypted data, and performing the classification task with respect to three or more labels in addition to the binary classification task.

### BACKGROUND OF THE INVENTION

### 1. Field of the Invention

The present invention relates to a method, a computing device, and a computer-readable medium for classifying encrypted data using a deep learning model, and more specifically, to a method, a computing device, and a computer-readable medium for classifying encrypted data using a deep learning model, in which original data is modified such that the original data can be used as training data in a deep learning-based inference model, and the original data and the modified data are encrypted through an optical-based encryption method, so that the encrypted data can be input into the inference model, and the encrypted data can be labeled with any one classification item among a plurality of classification items for classifying the encrypted data, thereby performing the labeling task with encrypted data itself without the process of decrypting the encrypted data, and performing the classification task with respect to three or more labels in addition to the binary classification task.

### 2. Description of the Related Art

Recently, with the development of science and technology, new technologies such as artificial intelligence, the Internet of Things, and augmented reality are being advanced and extensively spotlighted to people. Meanwhile, one of the essential elements for advancing and commercializing these technologies is big data. Big data refers to a large amount of data collected from various devices, the Internet, applications, etc., and the collected data includes not only standardized data, but also unstructured data.

Since the big data has a large size and various forms, a large-size storage space and powerful computing power to process the big data are required to store and manage the big data, resulting in enormous costs. However, these problems can be solved through the conventional cloud service, so that users and companies using the cloud service can efficiently deal with the tasks such as storage, management, and analysis of big data.

However, among data included in the big data, there is a large amount of data containing a large amount of personal information of users. For example, a third party may obtain personal information about when, with whom, and where the user has been through a photo uploaded by the user. For this reason, there are cases in which data stored in the cloud is revealed by a third party so that personal information is abused. In this regard, in recent years, various technical attempts have been made to enhance the security of data stored in the cloud.

In order to enhance the security of data stored in the cloud, a method of encrypting data and storing the encrypted data in the cloud, rather than storing the data itself in the cloud, is mainly used. As described above, there is an advantage of protecting personal information included in the data by encrypting and storing data in the cloud. To the contrary, as data is encrypted as described above, there is a problem in that the utility of big data for various purposes is lowered. For example, when decrypting each encrypted data in order to manage and analyze the big data composed of encrypted data, an additional processing time is required and computing power is increased due to the decrypting step. Accordingly, in order to solve the above problem, various methods for processing data in an encrypted state without decrypting the encrypted data have been recently developed.

For instance, as a conventional method for processing encrypted data, Non-Patent Document 1 proposes a method of processing (classifying) encrypted data using Convolutional Neural Networks (CNN) corresponding to a neural network model. However, in the case of Non-Patent Document 1, there is a restriction that only the task of classifying data into any one class among binary classes (true, false, etc.) among the classification tasks can be processed. Accordingly, there are still problems that are difficult to solve when classifying data as one class among multiple classes of three or more.

Therefore, in a method for classifying encrypted data, there is still a need for the invention of a new technique that can effectively and universally solve the classification problem for multiple classes.

### RELATED TECHNICAL DOCUMENTS

### Non-Patent Documents

(Non-Patent Document 1) V. M. Lidkea et al., “Convolutional neural network framework for encrypted image classification in cloud-based ITS,” IEEE Open Journal of Intelligent Transportation Systems, pp. 35-50, 2020

### SUMMARY OF THE INVENTION

The present invention relates to a method, a computing device, and a computer-readable medium for classifying encrypted data using a deep learning model, and more specifically, an object of the present invention is to provide a method, a computing device, and a computer-readable medium for classifying encrypted data using a deep learning model, in which original data is modified such that the original data can be used as training data in a deep learning-based inference model, and the original data and the modified data are encrypted through an optical-based encryption method, so that the encrypted data can be input into the inference model, and the encrypted data can be labeled with any one classification item among a plurality of classification items for classifying the encrypted data, thereby performing the labeling task with encrypted data itself without the process of decrypting the encrypted data, and performing the classification task with respect to three or more labels in addition to the binary classification task.

In order to accomplish the above object, one embodiment of the present invention provides a method for classifying encrypted data using a deep learning model executed in a computing device including at least one processor and at least one memory, the method including: a data augmentation step of generating one or more modified data for a corresponding original data by modifying one or more original data among a plurality of original data corresponding to unstructured data; a data encryption step of encrypting each of the plurality of original data and the one or more modified data generated through the data augmentation step using an optical-based encryption method; and a data classification step of labeling the encrypted data with any one of a plurality of classification items for classifying the encrypted data by inputting each of the data, which is encrypted through the data encryption step, into a deep learning-based inference model.

According to one embodiment of the present invention, the original data may correspond to image data, and the data augmentation step may include: a data transformation step of modifying the original data by flipping and/or shifting an image of the corresponding original data; and a mask transformation step of modifying each of a plurality of random phase masks for optically encrypting the original data in a same manner as the original data modified in the data transformation step.

According to one embodiment of the present invention, the data encryption step may include: encrypting the original data, which is modified through the data transformation step, with a plurality of random phase masks modified through the mask transformation step; and dividing the modified encrypted original data into a real part and an imaginary part.

According to one embodiment of the present invention, the data classification step may include: a first processing step of deriving a feature value of the encrypted data by repeatedly performing processes of inputting the encrypted data into the inference model and calculating through two convolutional layers and one max-pooling layer included in the inference model by N times (N is a natural number equal to or greater than 1); a second processing step of deriving a vector value corresponding to the number of the plurality of classification items by repeatedly performing a process of calculating the feature value of the encrypted data through a fully-connected layer included in the inference model by M times (M is a natural number equal to or greater than 1); and a third processing step of classifying the encrypted data as any one of the plurality of classification items by applying a softmax function to the vector value.

According to one embodiment of the present invention, the data classification step may include: a first processing step of deriving a feature value of the encrypted data by repeatedly performing processes of inputting the encrypted data into the inference model and calculating through two convolutional layers and one max-pooling layer included in the inference model by N times (N is a natural number equal to or greater than 1); a second processing step of deriving output date having a size identical to a size of the encrypted date by repeatedly performing a process of calculating the feature value of the encrypted data through one de-convolutional layer and two convolutional layers included in the inference model by K times (K is a natural number equal to or greater than 1); and a third processing step of deriving restored data for the encrypted data by applying a sigmoid function to the output data, and classifying the encrypted data as any one of the plurality of classification items based on the restored data.

According to one embodiment of the present invention, the data classification step may include: a first processing step of deriving a first feature value of the encrypted data by performing processes of inputting the encrypted data into the inference model and calculating through a first convolutional layer and a max-pooling layer included in the inference model; a second processing step of deriving a second feature value based on output value finally derived from a last block module by repeating processes of inputting the first feature value into a first block module among a plurality of block modules composed of two second convolutional layers included in the inference model, and inputting an output value derived from the first block module into a second block module; and a third processing step of classifying the encrypted data as any one of the plurality of classification items by performing a process of calculating the second feature value through an average-pooling layer and a fully-connected layer included in the inference model.

In order to accomplish the above object, one embodiment of the present invention provides a computing device for implementing a method for classifying encrypted data using a deep learning model and including at least one processor and at least one memory, wherein the computing device executes: a data augmentation step of generating one or more modified data for a corresponding original data by modifying one or more original data among a plurality of original data corresponding to unstructured data; a data encryption step of encrypting each of the plurality of original data and the one or more modified data generated through the data augmentation step using an optical-based encryption method; and a data classification step of labeling the encrypted data with any one of a plurality of classification items for classifying the encrypted data by inputting each of the data, which is encrypted through the data encryption step, into a deep learning-based inference model.

In order to accomplish the above object, one embodiment of the present invention provides a computer-readable medium for implementing a method for classifying encrypted data using a deep learning model executed in a computing device including at least one processor and at least one memory, wherein the computer-readable medium includes: computer-executable instructions for enabling the computing device to perform following steps including: a data augmentation step of generating one or more modified data for a corresponding original data by modifying one or more original data among a plurality of original data corresponding to unstructured data; a data encryption step of encrypting each of the plurality of original data and the one or more modified data generated through the data augmentation step using an optical-based encryption method; and a data classification step of labeling the encrypted data with any one of a plurality of classification items for classifying the encrypted data by inputting each of the data, which is encrypted through the data encryption step, into a deep learning-based inference model.

According to one embodiment of the present invention, a process of decrypting data is not performed when performing the task for encrypting data and classifying the encrypted data, so the effect of protecting personal information included in the data can be obtained.

According to one embodiment of the present invention, data can be encrypted by using an optical-based encryption method, so it is possible to effectively perform the task of classifying the encrypted data.

According to one embodiment of the present invention, the classification task can be performed with encrypted data itself, and the classification task for three or more classes can be performed in addition to the binary class classification task, so that a practical service can be provided through the data classification task.

### BRIEF DESCRIPTION OF THE DRAWINGS

FIG. 1 is a view schematically illustrating a process of encrypting data and classifying encrypted data through a computing device according to one embodiment of the present invention.

FIG. 2 is a view schematically illustrating internal components of a computing device performing a method for classifying encrypted data using a deep learning model according to one embodiment of the present invention.

FIG. 3 is a view schematically illustrating detailed steps of a method for classifying encrypted data using a deep learning model according to one embodiment of the present invention.

FIG. 4 is a view schematically illustrating sub-steps of a data augmentation step according to one embodiment of the present invention.

FIG. 5 is a view schematically illustrating a process in which one or more modified data are generated with respect to original data according to one embodiment of the present invention.

FIG. 6 is a view schematically illustrating sub-steps of a data encryption step according to one embodiment of the present invention.

FIG. 7 is a view schematically illustrating a process of encrypting data using an optical-based encryption method according to one embodiment of the present invention.

FIG. 8 is a view schematically illustrating a process of learning an inference model according to one embodiment of the present invention.

FIG. 9 is a view schematically illustrating the internal configuration of an inference model according to one embodiment of the present invention.

FIG. 10 is a view schematically illustrating a process of classifying encrypted data in an inference model according to one embodiment of the present invention.

FIG. 11 is a view schematically illustrating the internal configuration of an inference model according to another embodiment of the present invention.

FIG. 12 is a view schematically illustrating a process of classifying encrypted data in an inference model according to another embodiment of the present invention.

FIG. 13 is a view schematically illustrating the internal configuration of an inference model according to another embodiment of the present invention.

FIG. 14 is a view schematically illustrating a process of classifying encrypted data in an inference model according to another embodiment of the present invention.

FIG. 15 is a view schematically illustrating internal components of a computing device according to one embodiment of the present invention.

### DETAILED DESCRIPTION OF THE INVENTION

Hereinafter, various embodiments and/or aspects will be described with reference to the drawings. In the following description, numerous specific details are set forth in order to provide a thorough understanding of one or more aspects for the purpose of explanation. However, it will also be appreciated by a person having ordinary skill in the art that such aspect(s) may be carried out without the specific details. The following description and accompanying drawings will be set forth in detail for specific illustrative aspects among one or more aspects. However, the aspects are merely illustrative, some of various ways among principles of the various aspects may be employed, and the descriptions set forth herein are intended to include all the various aspects and equivalents thereof.

In addition, various aspects and features will be presented by a system that may include a plurality of devices, components and/or modules or the like. It will also be understood and appreciated that various systems may include additional devices, components and/or modules or the like, and/or may not include all the devices, components, modules or the like recited with reference to the drawings.

The term “embodiment”, “example”, “aspect”, “exemplification”, or the like as used herein may not be construed in that an aspect or design set forth herein is preferable or advantageous than other aspects or designs. The terms ‘unit’, ‘component’, ‘module’, ‘system’, ‘interface’ or the like used in the following generally refer to a computer-related entity, and may refer to, for example, hardware, software, or a combination of hardware and software.

In addition, the terms “include” and/or “comprise” specify the presence of the corresponding feature and/or component, but do not preclude the possibility of the presence or addition of one or more other features, components or combinations thereof.

In addition, the terms including an ordinal number such as first and second may be used to describe various components, however, the components are not limited by the terms. The terms are used only for the purpose of distinguishing one component from another component. For example, the first component may be referred to as the second component without departing from the scope of the present invention, and similarly, the second component may also be referred to as the first component. The term “and/or” includes any one of a plurality of related listed items or a combination thereof.

In addition, in embodiments of the present invention, unless defined otherwise, all terms used herein including technical or scientific terms have the same meaning as commonly understood by those having ordinary skill in the art. Terms such as those defined in generally used dictionaries will be interpreted to have the meaning consistent with the meaning in the context of the related art, and will not be interpreted as an ideal or excessively formal meaning unless expressly defined in the embodiment of the present invention.

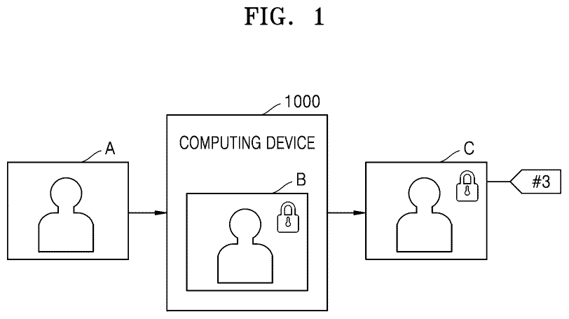

FIG. 1 is a view schematically illustrating a process of encrypting data and classifying encrypted data through a computing device 1000 according to one embodiment of the present invention.

As shown in FIG. 1, the computing device 1000 of the present invention may encrypt data A, and labels the encrypted data B with any one classification item among a plurality of classification items (classes), thereby classifying the encrypted data.

The computing device 1000 does not perform a process of decrypting the encrypted data (B) in labeling the encrypted data with any one classification item, but the encrypted data (B) itself, as shown in FIG. 1, is classified with any one of classification items using an inference model 1500 implemented based on deep learning.

Meanwhile, in the present invention, the original data (A) may mean various types of data, and the original data (A) preferably corresponds to unstructured data such as pictures, photos, reports, and contents of emails.

In this way, according to the present invention, the original data (A) corresponding to the unstructured data is encrypted, and the encrypted unstructured data can be classified through a deep learning-based inference model without a separate decryption process.

According to the present invention, the target of classification is unstructured data. In the case of conventional data encryption technology, a symmetric key-based encryption algorithm is adopted and the symmetric key-based encryption algorithm performs the encryption in a unit of a block having a limitation in size, which corresponds to a technology optimized for encryption of text-based data.

Therefore, in a situation where the production of various types of data, that is, unstructured data is rapidly increasing due to the advent of smartphones, etc., a considerable amount of time is required for calculation when the unstructured data such as photos, reports, and email contents are encrypted and decrypted through the symmetric key-based encryption algorithm, so there is a limitation to encrypt the unstructured data.

Therefore, according to the present invention, in order to rapidly encrypt the unstructured data and to enable classification for the encrypted unstructured data in a deep learning-based inference model, as will be described later, an optical-based encryption algorithm, more specifically, Fourier configuration or a Fresnel propagation-based double random phase encryption (DRPE) algorithm is used, and preferably, the original data A may correspond to image data including at least one image frame among unstructured data.

In addition, the classification task performed by the computing device 1000 of the present invention corresponds to the operation of labeling with any one classification item corresponding to the encrypted data among two or more preset classification items (classes). As described above, it is possible to perform a classification task of labeling with any one of three or more classification items as well as a binary class classification task of labeling with any one of two classification items.

Hereinafter, an internal configuration of the computing device 1000 and a method for classifying encrypted data using a deep learning model, which is performed through the computing device 1000, will be described in detail.

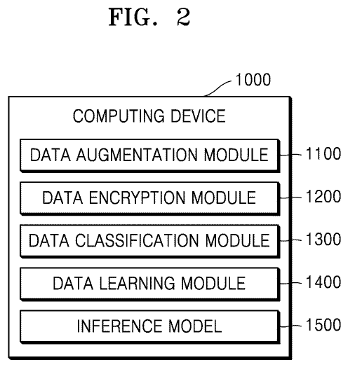

FIG. 2 is a view schematically illustrating internal components of a computing device 1000 performing a method for classifying the encrypted data using a deep learning module according to one embodiment of the present invention.

The computing device 1000 may include one or more processors and one or more memories, and as shown in FIG. 2, the computing device 1000 may include a data augmentation module 1100, a data encryption module 1200, a data classification module 1300, a data learning module 1400, and an inference model 1500, and the data augmentation module 1100, the data encryption module 1200, the data classification module 1300, and the data learning module 1400 may be implemented by a process performed by the one or more processors.

Meanwhile, the internal configuration of the computing device 1000 shown in FIG. 2 is schematically illustrated in order to facilitate the explanation for the description of the present invention, and the computing device 1000 may further include various other components that may be typically included in the computing device.

The data augmentation module 1100 performs a data augmentation step (S100), and generates one or more modified data for the corresponding original data by modifying a plurality of original data stored in the computing device 1000 or a plurality of original data received from a separate computing device such as a user terminal. In this way, the data augmentation module 1100 increases the size of data based on the original data, and the one or more modified data is used as data for the inference model 1500 to learn, or as data to verify the performance of the inference model 1500.

The data encryption module 1200 performs a data encryption step (S200) and generates encryption data by encrypting each of the plurality of original data and the plurality of modified data generated by the data augmentation module 1100. Specifically, the data encryption module 1200 may derive encrypted data using an optical-based encryption method as an encryption method for data.

The data classification module 1300 performs a data classification step (S300), and labels the encrypted data with any one classification item corresponding to the encrypted data among two or more preset classification items. Specifically, the data classification module 1300 performs labeling on the encrypted data using the inference model 1500, and the inference model 1500 may calculate a probability for each of two or more preset classification items for the encrypted data, and label any one classification item corresponding to the highest probability to the encrypted data.

The data learning module 1400 performs a data learning step, in which the data learning module 1400 performs a process of learning the inference model 1500 by using the plurality of encrypted data as learning data of the inference model 1500 to allow the inference model 1500 to effectively process the task of classifying a plurality of encrypted data. Meanwhile, according to another embodiment of the present invention, the inference model 1500 may be learned in advance by encrypted data, in this case, the data learning module 1400 may not be included in the computing device 1000, or the data learning step may be omitted.

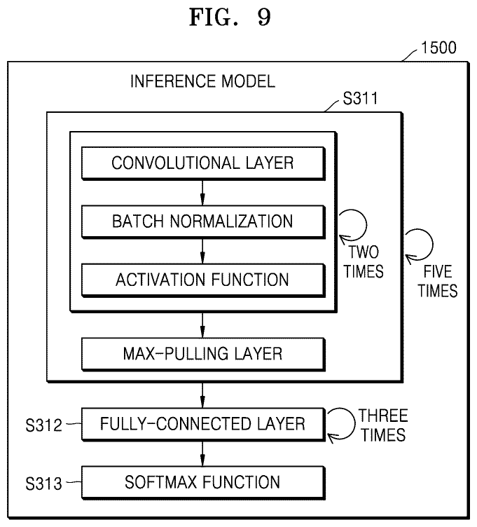

The inference model 1500 may be stored in the computing device 1000, and may label the data encrypted in the data classification step (S300) with any one classification item. Specifically, the inference model 1500 may include a deep learning-based structure, and various embodiments of the specific structure of the inference model 1500 will be described with reference to FIGS. 9 to 14.

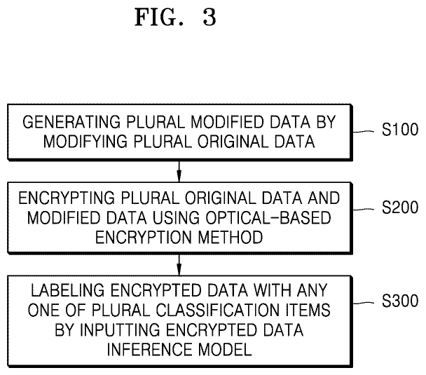

FIG. 3 is a view schematically illustrating detailed steps of a method for classifying encrypted data using a deep learning model according to one embodiment of the present invention.

As shown in FIG. 3, a method for classifying encrypted data using a deep learning model executed in a computing device 1000 including at least one processor and at least one memory may include: a data augmentation step (S100) of generating one or more modified data for a corresponding original data by modifying one or more original data among a plurality of original data corresponding to unstructured data; a data encryption step (S200) of encrypting each of the plurality of original data and the one or more modified data generated through the data augmentation step (S100) using an optical-based encryption method; and a data classification step (S300) of labeling the encrypted data with any one of a plurality of classification items for classifying the encrypted data by inputting each of the data, which is encrypted through the data encryption step (S200), into a deep learning-based inference model 1500.

Specifically, the data augmentation step (S100) transforms a plurality of original data stored in the computing device 1000 or received from an external device in various ways to generate one or more modified data for the corresponding original data. In this way, the data augmentation step (S100) augments the size of the data, so the data can be used as learning data allowing the inference model 1500 that performs the task of classifying a plurality of original data to accurately classify the plurality of original data or can be used as data for verifying the performance of the inference model 1500.

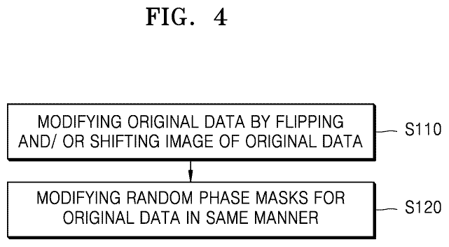

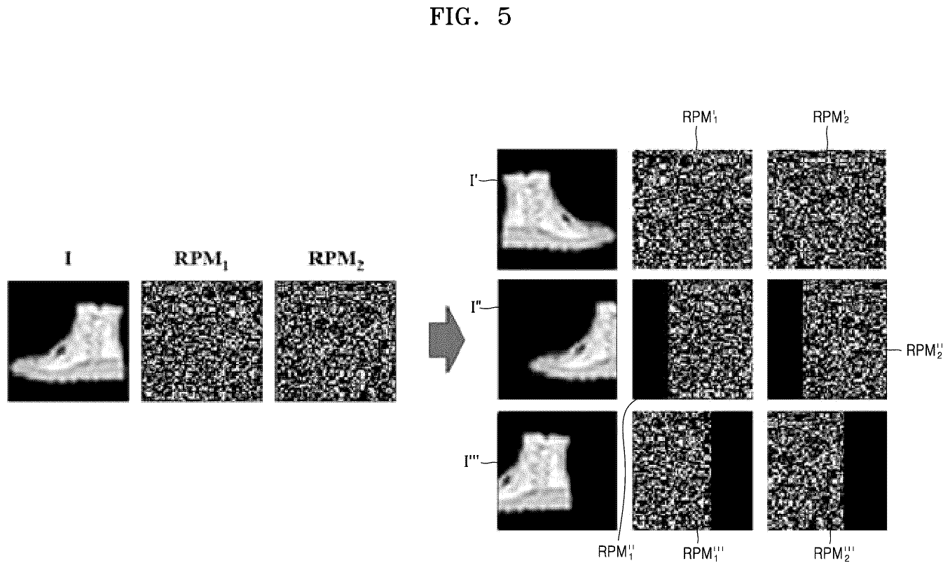

Meanwhile, the detailed process of generating the modified data in the data augmentation step (S100) will be described later with reference to FIGS. 4 and 5.

The data encryption step (S200) encrypts a plurality of original data and modified data in order to protect personal information included in the plurality of original data and modified data. More specifically, the data encryption step (S200) encrypts a plurality of original data and modified data using an optical-based encryption method.

In the case of a block encryption technology mainly used as a conventional encryption method, data is divided into bits of a predetermined size, and encryption is performed for each divided unit. However, when the data to be encrypted is an image or image-based data including one or more image frames, the data may be expressed as 8 bits for one pixel in case of a gray scale and expressed as 24 bits in case of a color scale, that is, 8 bits for each of RGB. Since a large number of pixels are included, in the case of encryption the data using block encryption technology, it is very inefficient because the data needs to be divided and encrypted in a number of bits. In addition, there is a problem in that it is difficult to perform the labeling task with the data encrypted based on the block encryption technology.

Therefore, in the data encryption step (S200) of the present invention, the data is encrypted based on the optical-based encryption method such as Double Random Phase Encoding (DRPE), instead of encrypting the data based on the block encryption technology, so that it is possible to effectively perform the labeling task for the data encrypted in the data classification step (S300) and the labeling task for three or more classification items can also be effectively performed.

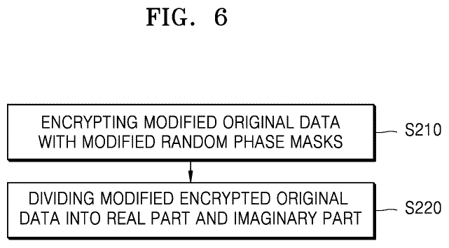

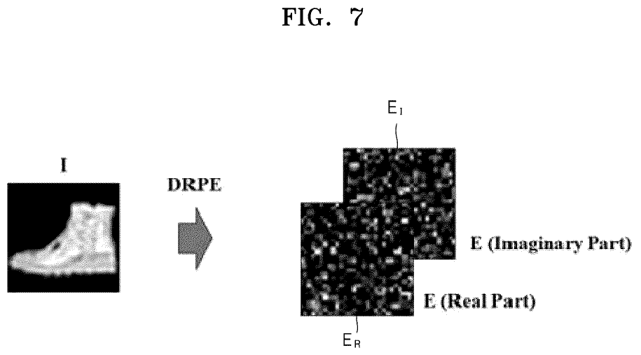

Meanwhile, a detailed method of encrypting data using an optical-based encryption method in the data encryption step S200 will be described later with reference to FIGS. 6 and 7.

The data classification step (S300) uses the inference model 1500 having a deep learning structure for each of the data encrypted through the data encryption step (S200) to label the encrypted data with any one classification item.

Meanwhile, each of the plurality of original data described below is image data including one or more image frames, and preferably corresponds to a grayscale image having a size of 32×32 pixels and it is assumed that the number of a plurality of classification items for classifying the original data is 10.

FIG. 4 is a view schematically illustrating sub-steps of the data augmentation step (S100) according to one embodiment of the present invention.

As shown in FIG. 4, the original data corresponds to image data, and the data augmentation step S100 may include: a data transformation step (S110) of modifying the original data by flipping and/or shifting an image of the corresponding original data; and a mask transformation step (S120) of modifying each of a plurality of random phase masks for optically encrypting the original data in the same manner as the original data modified in the data transformation step (S110).

Specifically, the data augmentation step (S100) not only modifies the original data, but also modifies the random phase masks used to encrypt the original data using an optical-based encryption method the same as that of the original data.

More specifically, the data augmentation step (S100) includes a data transformation step (S110), and the data transformation step (S110) modifies the original data in one or more ways to generate modified data for the corresponding original data. In the one or more ways, an image (one or more image frames) included in the original data is inverted in left/right or up/down directions, or shifted in a predetermined direction by a preset size.

In addition, in the data transformation step (S110), the original data is modified not only by applying only any one of the above-described inversion or shift, but also by applying two or more ways, that is, by applying both inversion and shift.

Meanwhile, the data augmentation step (S100) further includes a mask transformation step (S120), and the mask transformation step (S120) modifies a plurality of random phase masks, which are used to optically encrypt the original data modified in the data transformation step (S110), in the same manner as the method used for modifying the original data in the data transformation step (S110).

Specifically, the data encryption step (S200) of the present invention encrypts image data by a double random phase encoding (DRPE) method among optical-based encryption methods, in which at least two random phase masks that serve as a kind of key used for encrypting the image data in double random phase encoding method are required, and the mask transformation step (S120) modifies each of two or more random phase masks.

In addition, in the mask transformation step S120, each of the plurality of random phase masks corresponding to the corresponding original data is modified in the same manner as the method of modifying the corresponding original data in the data transformation step (S110). For example, when the modified data is generated by inverting the left/right of the original data in the data transformation step (S110), each of two or more random phase masks corresponding to the original data may also be modified by inverting the left/right of the original data in the mask transformation step S120.

FIG. 5 is a view schematically illustrating a process in which one or more modified data are generated with respect to original data according to one embodiment of the present invention.

FIG. 5 schematically illustrates a process in which the original data and a plurality of random phase masks for encrypting the original data are modified through the data augmentation step (S100).

As shown in FIG. 5, with respect to the original data I, a plurality of modified data (I′, I″ and I′″ for the original data I) are generated in various ways in the data transformation step (S110).

Referring to FIG. 5 as an example, in the data transformation step (S110), modified data I′ is generated by flipping the left/right sides of the original data I, modified data I″ is generated by shifting the original data I to the right by a predetermined size, and modified data I′″ is generated by shifting the original data I to the left by a predetermined size.

Meanwhile, a plurality of random phase masks are also modified in the same manner as the method for modifying the original data in the mask transformation step (S120).

Referring to FIG. 5 as an example, in the mask transformation step S120, with respect to the plurality of random phase masks RPM₁ and RPM₂ corresponding to the original data, modified random phase masks RPM_{1′} and RPM_{2′} are generated in case of first modified data I′ by inverting left/right of each of the plurality of random phase masks RPM₁ and RPM₂, modified random phase masks RPM_{1″} and RPM_{2″} are generated in case of second modified data I″ by shifting each of the random phase masks RPM₁ and RPM₂ to the right, and modified random phase masks RPM_{1′″} and RPM_{2′″} are generated in case of third modified data I′″ by shifting each of the random phase masks RPM₁ and RPM₂ to the left.

As described above, the modified data obtained by modifying the original data in the data transformation step (S110) can be encrypted through an optical-based encryption method by a plurality of random phase masks modified in the same manner as the method of modifying the original data in the mask transformation step (S120).

Meanwhile, the method of modifying the original data described with reference to FIGS. 4 and 5 may not be limited to inversion and shifting, and the original data may be modified in various other ways. For example, the original data can be modified through other additional methods by rotating the original data clockwise or counterclockwise by a preset size, or by applying one or more preset masking elements to the original data such that a part of the original data can be masked by one or more preset masking elements. Thus, the mask transformation step (S120) may modify the random phase mask according to the additional method performed in the above-described data transformation step (S110).

FIG. 6 is a view schematically illustrating sub-steps of the data encryption step (S200) according to one embodiment of the present invention.

As shown in FIG. 6, the data encryption step (S200) may include a step (S210) of encrypting the original data, which is modified through the data transformation step (S110), with a plurality of random phase masks modified through the mask transformation step (S120); and a step (S220) of dividing the modified encrypted original data into a real part and an imaginary part.

Specifically, in step S210, the modified original data is encrypted with a plurality of modified random phase masks corresponding to the modified original data. The random phase mask, like the plurality of random phase masks RPM₁ and RPM₂ shown in FIG. 5, is configured in the form of a two-dimensional white noise image, and is a kind of key for encrypting the original data, preferably a kind of public key. In addition, the random phase mask can be expressed as e^{jθ(x,y)}), in which (x,y) is a coordinate within a random phase mask, and θ is a random phase distribution within a range from −n to n.

Meanwhile, in step S220, in order to label the data encrypted through the double random phase encoding method in step S210 with any one classification item in the inference model 1500, the encrypted data is divided into a real part and an imaginary part and the divided real part and imaginary part are combined as one data set.

In this way, the real part and imaginary part divided through step S220 are input into the inference model 1500 in the data classification step (S300), and the inference model 1500 may perform the labelling task for the encrypted data corresponding to the input real part and imaginary part.

In addition, in the data encryption step (S200), the encryption is not limited to only the modified data, but both the modified data and the original data may be encrypted using a random phase mask, and the encrypted data is divided into a real part and an imaginary part and then combined.

Meanwhile, according to another embodiment of the present invention, the data encrypted through step S210 is stored in the computing device 1000, and the real part and the imaginary part divided in the data encrypted in step S220 are data generated in the pre-processing procedure for labeling the corresponding encrypted data, in which the corresponding data is used only in the process for labeling the encrypted data, and may not be separately stored in the computing device 1000.

FIG. 7 is a view schematically illustrating a process of encrypting data using an optical-based encryption method according to one embodiment of the present invention.

FIG. 7 schematically illustrates a process in which original data and modified data are encrypted using an optical-based encryption method through the data encryption step (S200), and then divided into a real part and an imaginary part.

As an example, FIG. 7 schematically shows a process of performing the data encryption step S200 based on the original data I. Referring to FIG. 7 as an example, as described above, the original data I is encrypted using an optical-based encryption method such as double random phase encoding in step S210. Meanwhile, although not shown in FIG. 7, the original data I is encrypted using a plurality of random phase masks corresponding to the original data I in step S210.

As shown on the right side of FIG. 7, when the original data I is encrypted using a plurality of random phase masks configured in the form of white noise, the encrypted data does not optically identify the original data I.

In addition, as shown on the right side of FIG. 7, in above-described step S220, the encrypted data is divided into a real part E_{R} and an imaginary part E_{I}, and the divided real part E_{R} and imaginary part E_{I} are combined as one data and input into the inference model 1500.

Meanwhile, a plurality of random phase masks may be stored in the computing device 1000, and a plurality of different random phase masks for each of the plurality of original data may be stored in the computing device 1000. However, preferably, a pair of random phase masks are stored in the computing device 1000, and each of the plurality of original data may be commonly encrypted by a pair of random phase masks.

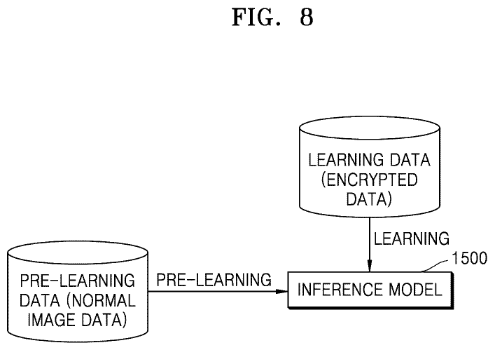

FIG. 8 is a view schematically illustrating a process of learning an inference model 1500 according to one embodiment of the present invention.

As shown in FIG. 8, the deep learning-based inference model 1500 may perform the learning twice. First, the inference model 1500 may receive a large amount of pre-learning data through the data learning step performed by the data learning module 1400 to perform the pre-learning, in which the pre-learning data may be unencrypted general image data. Second, the pre-learning data used in the pre-learning may have a larger scale than the learning data used when the inference model 1500 performs the learning. Meanwhile, a preset classification item (labeling) may be assigned to each image data included in the pre-learning data.

Meanwhile, the inference model 1500 pre-learned with the pre-learning data may receive learning data through the data learning step performed by the data learning module 1400 to perform the learning. In this case, the learning data may correspond to a part of the plurality of encrypted data for the plurality of original data and the plurality of modified data in the data encryption step (S200).

In this way, the inference model 1500 may perform a process of adjusting the values of a plurality of weights included in the inference model 1500 as it learns the learning data, and the learned inference model 1500 may perform the optimal classification task for the encrypted data through the adjusted weight values.

In addition, according to another embodiment of the present invention, the initial inference model 1500 may correspond to the inference model 1500 pre-trained with the above-described pre-learning data, and in this case, the data learning module 1400 may perform only the second process of training the inference model 1500 based on the encrypted data.

Meanwhile, in the following description, three embodiments of the deep learning structure of the inference model 1500 that has recorded high performance for the task of labeling the encrypted data with any one classification item performed in the inference model 1500 of the present invention will be explained.

FIG. 9 is a view schematically illustrating the internal configuration of the inference model 1500 according to one embodiment of the present invention.

As shown in FIG. 9, the data classification step (S300) may include: a first processing step (S311) of deriving a feature value of the encrypted data by repeatedly performing processes of inputting the encrypted data into the inference model 1500 and calculating through two convolutional layers and one max-pooling layer included in the inference model 1500 by N times (N is a natural number equal to or greater than 1); a second processing step (S312) of deriving a vector value corresponding to the number of the plurality of classification items by repeatedly performing a process of calculating the feature value of the encrypted data through a fully-connected layer included in the inference model 1500 by M times (M is a natural number equal to or greater than 1); and a third processing step (S313) of classifying the encrypted data as any one of the plurality of classification items by applying a softmax function to the vector value.

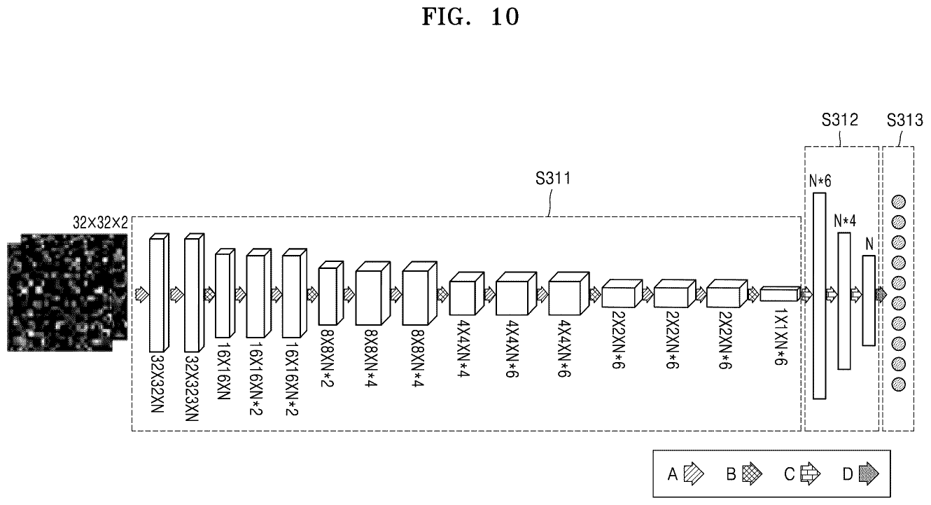

FIG. 9 and FIG. 10 to be described later schematically show the inference model 1500 having a structure based on a Convolutional Neural Network (CNN) according to one embodiment of the present invention.

Specifically, as shown in FIGS. 9 and 10, the inference model 1500 having the CNN structure may be largely composed of a combination of four (A, B, C, and D) calculation processes.

The calculation process A includes a convolution layer that performs a convolution calculation by applying a filter having a size of 3×3. Preferably, the calculation process A may additionally include a calculation according to the batch normalization and activation function on the value output from the convolution layer, and determine whether to activate or deactivate the value derived from the calculation process A. Meanwhile, the calculation process A may be repeatedly performed twice, and the calculated value may be input to a calculation process B.

The calculation process B includes a max-pooling layer that performs the calculation to reduce the size of the image activated by the calculation process A.

Meanwhile, the first processing step (S311) may be understood to include the above-described calculation process A and calculation process B, and the first processing step (S311) may be repeatedly performed N times (N is a natural number greater than or equal to 1), and preferably, the natural number N may correspond to 5.

A calculation process C may include a fully-connected layer that receives the feature values derived through the first processing step (S311) to derive vector values corresponding to the number of a plurality of classification items, and the second processing step (S312) may include the calculation process C, in which the second processing step S312 may be repeatedly performed M times (M is a natural number equal to or greater than 1), and preferably, the natural number M may correspond to 3.

A calculation process D corresponds to a process of classifying the vector value calculated through the second processing step (S312) as any one of a plurality of classification items using a softmax function, and the third processing step (S313) includes a calculation process D.

Meanwhile, as shown in FIG. 10, the process of repeatedly performing the steps multiple times in the CNN-based inference model 1500 according to one embodiment of the present invention may be understood as it includes a plurality of corresponding elements. For example, as shown in FIG. 10, when the first processing step (S311) including the calculation process A and the calculation process B is repeatedly performed 5 times, it can be understood that the inference model 1500 includes five elements for performing the first processing step (S311).

In addition, as shown in FIG. 10, whenever the first processing step S311 is repeatedly performed 5 times, the size of the image may decrease and the depth may increase.

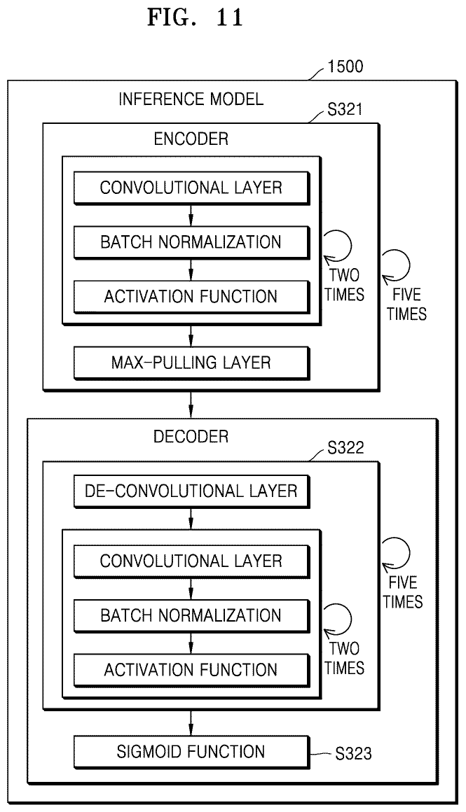

FIG. 11 is a view schematically illustrating the internal configuration of an inference model 1500 according to another embodiment of the present invention.

As shown in FIG. 11, the data classification step (S300) may include: a first processing step (S321) of deriving a feature value of the encrypted data by repeatedly performing processes of inputting the encrypted data into the inference model 1500 and calculating through two convolutional layers and one max-pooling layer included in the inference model by N times (N is a natural number equal to or greater than 1); a second processing step (S322) of deriving output date having a size identical to a size of the encrypted date by repeatedly performing a process of calculating the feature value of the encrypted data through one de-convolutional layer and two convolutional layers included in the inference model 1500 by K times (K is a natural number equal to or greater than 1); and a third processing step (S323) of deriving restored data for the encrypted data by applying a sigmoid function to the output data, and classifying the encrypted data as any one of the plurality of classification items based on the restored data.

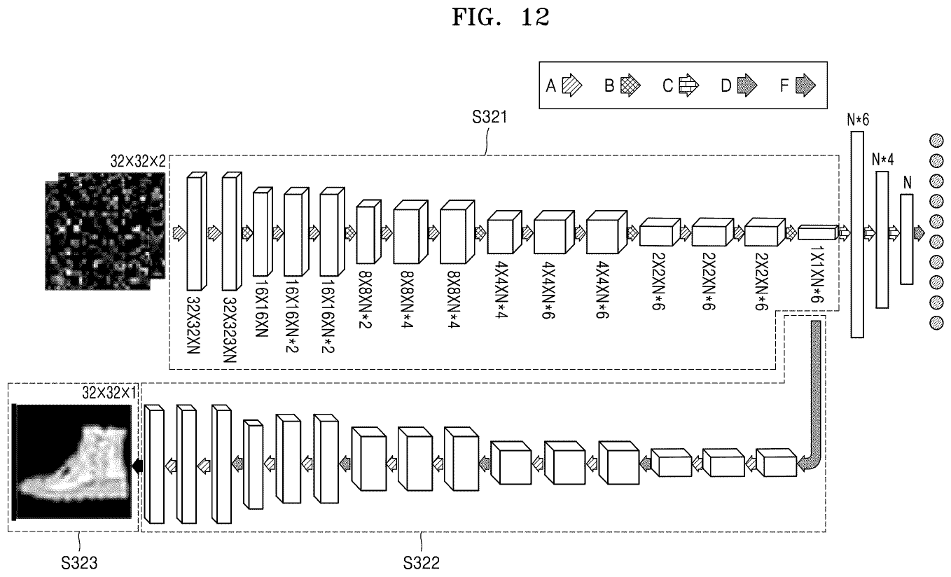

FIG. 11 and FIG. 12 to be described later schematically show an inference model 1500 having an AutoEncoder-based structure that derives output data by inferring input data to restore the input data according to another embodiment of the present invention.

Specifically, as shown in FIGS. 11 and 12, the inference model 1500 having an AutoEncoder structure may be largely composed of a combination of four (A, B, E, and F) calculation processes.

The calculation process A and the calculation process B are the same as those included in the inference model 1500 having the CNN structure described above with reference to FIGS. 9 and 10, and an encoder included in the inference model 1500 may include the calculation process A and the calculation process B to perform the first processing step (S321).

The calculation process E includes a de-convolution layer that receives the feature value derived in the first processing step (S321) to perform the calculation that returns the feature values to the state before applying the calculation in the convolution layer included in the encoder, and a filter having a size of 2×2 may be used in the de-convolution layer.

Meanwhile, the second processing step (S322) may include the calculation process E and the calculation process A receiving the output value derived from the calculation process E for calculation, and the second processing step (S322) may be repeated K times (K is a natural number equal to or greater than 1), and preferably, the natural number K may correspond to 5.

The size of the output data derived by the second processing step S322 may be the same as the encrypted data input into the encoder, that is, the output data may mean a kind of restored data for the input encrypted data.

Meanwhile, the calculation process F may derive restored data obtained by restoring the encrypted data finally input into the inference model 1500 by applying the sigmoid function to the output data derived in the second processing step (S322), which is repeatedly performed K times, and may perform a process of classifying the data as any one of a plurality of classification items based on the restored data. The third processing step (S323) may be understood as it includes the calculation F.

Preferably, in the calculation process F, the calculation according to the convolution layer may be preferentially performed before applying the sigmoid function to the output data.

As shown in FIG. 11, a decoder may include a calculation process E, a calculation process A, and a calculation process F, and as described above, may perform the second processing step (S322) and the third processing step (S323).

As shown in FIG. 12, the inference model 1500 having the AutoEncoder structure according to another embodiment of the present invention can be understood as a configuration that utilizes some components (the calculation process A and the calculation process B) included in the inference model 1500 having the CNN structure.

In addition, as shown in FIG. 12, the inference model 1500 having the AutoEncoder structure may receive the encrypted data to restore the encrypted data, and may perform the labeling task for the encrypted data based on the restored data. In this case, restoring the encrypted data in the inference model 1500 may be understood as a different concept from decrypting the encrypted data.

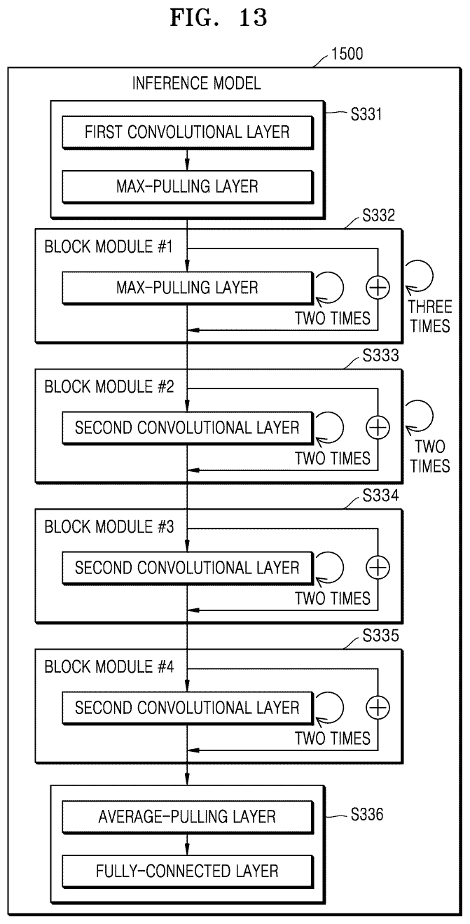

FIG. 13 is a view schematically illustrating the internal configuration of an inference model 1500 according to another embodiment of the present invention.

As shown in FIG. 13, the data classification step (S300) may include: a first processing step of deriving a first feature value of the encrypted data by performing processes of inputting the encrypted data into the inference model 1500 and calculating through a first convolutional layer and a max-pooling layer included in the inference model 1500; a second processing step of deriving a second feature value based on output value finally derived from a last block module by repeating processes of inputting the first feature value into a first block module among a plurality of block modules composed of two second convolutional layers included in the inference model 1500, and inputting an output value derived from the first block module into a second block module; and a third processing step of classifying the encrypted data as any one of the plurality of classification items by performing a process of calculating the second feature value through an average-pooling layer and a fully-connected layer included in the inference model 1500.

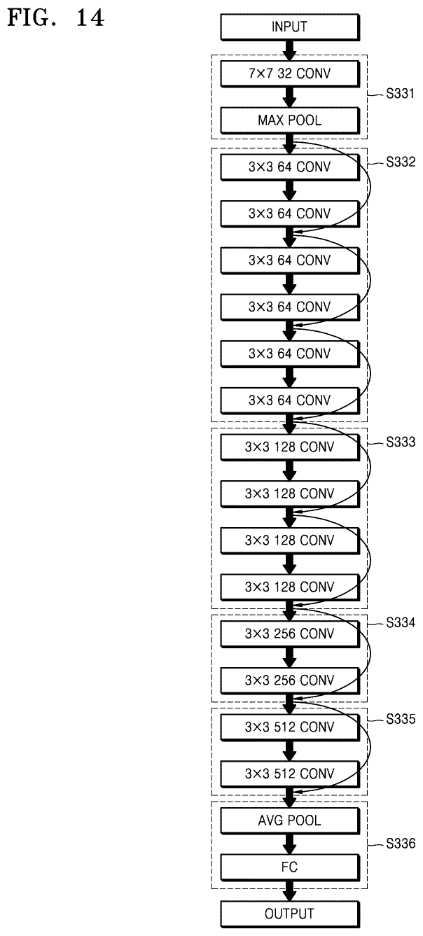

FIG. 13 and FIG. 14 to be described later schematically show an inference model 1500 having a structure based on a Residual Network (ResNet) implemented in a Residual Learning method according to another embodiment of the present invention.

Specifically, as shown in FIGS. 13 and 14, the inference model 1500 having the ResNet structure may largely perform the processes of the first processing step (S331) to the third processing step (S333).

In the first processing step (S331), a first feature value may be derived by performing the calculations in the first convolution layer included in the inference model 1500 and in the max-pooling layer that reduces the size of an image by receiving an output from the first convolution layer. Specifically, a filter having a size of 7×7 may be used in the first convolution layer.

The second processing step may include a plurality of sub-steps (S332 to S335), and each sub-step (S332 to S335) may be performed by each of a plurality of block modules (block modules #1 to block modules #) included in the inference model 1500.

Meanwhile, two second convolutional layers are connected to each block module, and the output value of the block module may correspond to a value obtained by adding a value input into the corresponding block module to a value output through the two second convolutional layers. In this case, when the dimension of the value output through the two second convolution layers is different from the dimension of the value input into the corresponding block module, a separate calculation may be performed for matching the dimensions of the two values.

In addition, as shown in FIG. 13, it may be understood that each block module includes one second convolution layer, and the second convolution layer is repeatedly performed twice.

In addition, each block module is sequentially connected, in which the first block module (block module #1) performs sub-step S332, which receives the first feature value derived in the first processing step (S331) to derive the output value, the second block module (block module #2) performs sub-step S333, which receives the output value derived from sub-step S331 to derive the output value, and the last block module (block module #4) performs sub-step S335 so that the derived output value may correspond to the second feature value.

Meanwhile, as shown in FIG. 13, sub-step S332 may be repeated three times in the first block module (block module #1), and sub-step S333 may be repeated twice in the second block module (block module #2). In addition, the second convolution layer included in each block module may use a filter having a size of 3×3.

Finally, in the third processing step (S336), the second feature value derived in the second processing step is received, vector values corresponding to the number of a plurality of classification items are calculated by performing the calculation through the average-pooling layer and the fully-connected layer, and the encrypted data is labelled with any one classification item having the highest probability based on the calculated vector values.

Meanwhile, as shown in FIG. 14, according to one embodiment of the present invention, whenever the sub-steps (S332 to S335) included in the second processing step are sequentially performed, the depth of the image may gradually increase.

As described above, each of the inference models 1500 according to three embodiments can learn a plurality of weight values for effectively classifying the encrypted data through the process of learning some data among the encrypted data with respect to each of the plurality of original data and the plurality of modified data.

Meanwhile, in order to learn a plurality of weight values in the inference model 1500, cross-entropy (CE) is used as a loss function, and in the case of the above-described AutoEncoder-based inference model 1500, a mean absolute error (MAE) may be used as a loss function for the decoder result, wherein each loss function may be defined as follows.

$$C E = - \frac{1}{N} ( {\sum }_{c = 1}^{M} {y}_{o c} log ( {p}_{o c} ) ) ,$$

$$M A E = \frac{1}{MN} {\sum }_{i = 1}^{M} {\sum }_{j = 1}^{N} \vert P ( i , j ) - G ( i , j ) \vert ,$$

In addition, in order to optimize the weight values during the learning process of the inference model 1500, stochastic gradient descent (SGD) may be used at a moment value of 0.9.

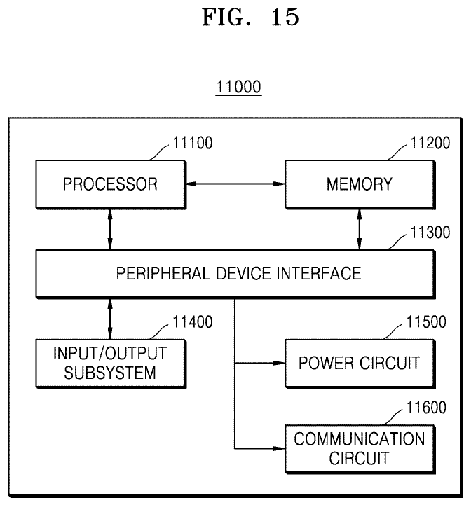

FIG. 15 schematically shows internal components of the computing device according to one embodiment of the present invention. The above-described computing device 1000 shown in FIG. 1 may include components of the computing device 11000 shown in FIG. 15.

As shown in FIG. 15, the computing device 11000 may at least include at least one processor 11100, a memory 11200, a peripheral device interface 11300, an input/output subsystem (I/O subsystem) 11400, a power circuit 11500, and a communication circuit 11600. The computing device 11000 may correspond to the computing device 1000 shown in FIG. 1.

The memory 11200 may include, for example, a high-speed random access memory, a magnetic disk, an SRAM, a DRAM, a ROM, a flash memory, or a non-volatile memory. The memory 11200 may include a software module, an instruction set, or other various data necessary for the operation of the computing device 11000.

The access to the memory 11200 from other components of the processor 11100 or the peripheral interface 11300, may be controlled by the processor 11100.

The peripheral interface 11300 may combine an input and/or output peripheral device of the computing device 11000 to the processor 11100 and the memory 11200. The processor 11100 may execute the software module or the instruction set stored in memory 11200, thereby performing various functions for the computing device 11000 and processing data.

The input/output subsystem may combine various input/output peripheral devices to the peripheral interface 11300. For example, the input/output subsystem may include a controller for combining the peripheral device such as monitor, keyboard, mouse, printer, or a touch screen or sensor, if needed, to the peripheral interface 11300. According to another aspect, the input/output peripheral devices may be combined to the peripheral interface 11300 without passing through the I/O subsystem.

The power circuit 11500 may provide power to all or a portion of the components of the terminal. For example, the power circuit 11500 may include a power failure detection circuit, a power converter or inverter, a power status indicator, a power failure detection circuit, a power converter or inverter, a power status indicator, or any other components for generating, managing, and distributing the power.

The communication circuit 11600 may use at least one external port, thereby enabling communication with other computing devices.

Alternatively, as described above, if necessary, the communication circuit 11600 may transmit and receive an RF signal, also known as an electromagnetic signal, including RF circuitry, thereby enabling communication with other computing devices.

The above embodiment of FIG. 15 is merely an example of the computing device 11000, and the computing device 11000 may have a configuration or arrangement in which some components shown in FIG. 15 are omitted, additional components not shown in FIG. 15 are further provided, or at least two components are combined. For example, a computing device for a communication terminal in a mobile environment may further include a touch screen, a sensor or the like in addition to the components shown in FIG. 15, and the communication circuit 11600 may include a circuit for RF communication of various communication schemes (such as WiFi, 3G, LTE, Bluetooth, NFC, and Zigbee). The components that may be included in the computing device 11000 may be implemented by hardware, software, or a combination of both hardware and software which include at least one integrated circuit specialized in a signal processing or an application.

The methods according to the embodiments of the present invention may be implemented in the form of program instructions to be executed through various computing devices, thereby being recorded in a computer-readable medium. In particular, a program according to an embodiment of the present invention may be configured as a PC-based program or an application dedicated to a mobile terminal. The application to which the present invention is applied may be installed in the computing device 11000 through a file provided by a file distribution system. For example, a file distribution system may include a file transmission unit (not shown) that transmits the file according to the request of the computing device 11000.

The above-mentioned device may be implemented by hardware components, software components, and/or a combination of hardware components and software components. For example, the devices and components described in the embodiments may be implemented by using at least one general purpose computer or special purpose computer, such as a processor, a controller, an calculation logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and at least one software application executed on the operating system. In addition, the processing device may access, store, manipulate, process, and create data in response to the execution of the software. For the further understanding, some cases may have described that one processing device is used, however, it is well known by those skilled in the art that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, and an instruction, or a combination of at least one thereof, and may configure the processing device to operate as desired, or may instruct the processing device independently or collectively. In order to be interpreted by the processor or to provide instructions or data to the processor, the software and/or data may be permanently or temporarily embodied in any type of machine, component, physical device, virtual equipment, computer storage medium or device, or in a signal wave to be transmitted. The software may be distributed over computing devices connected to networks, so as to be stored or executed in a distributed manner. The software and data may be stored in at least one computer-readable recording medium.

The method according to the embodiment may be implemented in the form of program instructions to be executed through various computing mechanisms, thereby being recorded in a computer-readable medium. The computer-readable medium may include program instructions, data files, data structures, and the like, independently or in combination thereof. The program instructions recorded on the medium may be specially designed and configured for the embodiment, or may be known to those skilled in the art of computer software so as to be used. An example of the computer-readable medium includes a magnetic medium such as a hard disk, a floppy disk and a magnetic tape, an optical medium such as a CD-ROM and a DVD, a magneto-optical medium such as a floptical disk, and a hardware device specially configured to store and execute a program instruction such as ROM, RAM, and flash memory. An example of the program instruction includes a high-level language code to be executed by a computer using an interpreter or the like as well as a machine code generated by a compiler. The above hardware device may be configured to operate as at least one software module to perform the operations of the embodiments, and vice versa.

According to one embodiment of the present invention, since a process of decrypting data is not performed when encrypting data and classifying the encrypted data, the effect of protecting personal information included in data can be obtained.

According to one embodiment of the present invention, data can be encrypted using an optical-based encryption method, so it is possible to effectively perform the task of classifying the encrypted data.

According to one embodiment of the present invention, the classification task can be performed with encrypted data itself, and not only the binary class classification task, but also the classification task for three or more classes can be performed, so that a practical service can be provided through the data classification task.

Although the above embodiments have been described with reference to the limited embodiments and drawings, however, it will be understood by those skilled in the art that various changes and modifications may be made from the above-mentioned description. For example, even though the described descriptions may be performed in an order different from the described manner, and/or the described components such as system, structure, device, and circuit may be coupled or combined in a form different from the described manner, or replaced or substituted by other components or equivalents, appropriate results may be achieved.

Therefore, other implementations, other embodiments, and equivalents to the claims are also within the scope of the following claims.

What is claimed is:

1. A method for classifying encrypted data using a deep learning model executed in a computing device including at least one processor and at least one memory, the method comprising:
a data augmentation step of generating one or more modified data for a corresponding original data by modifying one or more original data among a plurality of original data corresponding to unstructured data;
a data encryption step of encrypting each of the plurality of original data and the one or more modified data generated through the data augmentation step using an optical-based encryption method; and
a data classification step of labeling the encrypted data with any one of a plurality of classification items for classifying the encrypted data by inputting each of the data, which is encrypted through the data encryption step, into a deep learning-based inference model.

2. The method of claim 1, wherein the original data corresponds to image data, and
the data augmentation step includes:
a data transformation step of modifying the original data by flipping and/or shifting an image of the corresponding original data; and
a mask transformation step of modifying each of a plurality of random phase masks for optically encrypting the original data in a same manner as the original data modified in the data transformation step.

3. The method of claim 2, wherein the data encryption step includes:
encrypting the original data, which is modified through the data transformation step, with a plurality of random phase masks modified through the mask transformation step; and
dividing the modified encrypted original data into a real part and an imaginary part.

4. The method of claim 1, wherein the data classification step includes:
a first processing step of deriving a feature value of the encrypted data by repeatedly performing processes of inputting the encrypted data into the inference model and calculating through two convolutional layers and one max-pooling layer included in the inference model by N times (N is a natural number equal to or greater than 1);
a second processing step of deriving a vector value corresponding to the number of the plurality of classification items by repeatedly performing a process of calculating the feature value of the encrypted data through a fully-connected layer included in the inference model by M times (M is a natural number equal to or greater than 1); and
a third processing step of classifying the encrypted data as any one of the plurality of classification items by applying a softmax function to the vector value.

5. The method of claim 1, wherein the data classification step includes:
a first processing step of deriving a feature value of the encrypted data by repeatedly performing processes of inputting the encrypted data into the inference model and calculating through two convolutional layers and one max-pooling layer included in the inference model by N times (N is a natural number equal to or greater than 1);
a second processing step of deriving output date having a size identical to a size of the encrypted date by repeatedly performing a process of calculating the feature value of the encrypted data through one de-convolutional layer and two convolutional layers included in the inference model by K times (K is a natural number equal to or greater than 1); and
a third processing step of deriving restored data for the encrypted data by applying a sigmoid function to the output data, and classifying the encrypted data as any one of the plurality of classification items based on the restored data.

6. The method of claim 1, wherein the data classification step includes:
a first processing step of deriving a first feature value of the encrypted data by performing processes of inputting the encrypted data into the inference model and calculating through a first convolutional layer and a max-pooling layer included in the inference model;
a second processing step of deriving a second feature value based on output value finally derived from a last block module by repeating processes of inputting the first feature value into a first block module among a plurality of block modules composed of two second convolutional layers included in the inference model, and inputting an output value derived from the first block module into a second block module; and
a third processing step of classifying the encrypted data as any one of the plurality of classification items by performing a process of calculating the second feature value through an average-pooling layer and a fully-connected layer included in the inference model.

7. A computing device for implementing a method for classifying encrypted data using a deep learning model and including at least one processor and at least one memory, wherein the computing device executes:
a data augmentation step of generating one or more modified data for a corresponding original data by modifying one or more original data among a plurality of original data corresponding to unstructured data;
a data encryption step of encrypting each of the plurality of original data and the one or more modified data generated through the data augmentation step using an optical-based encryption method; and
a data classification step of labeling the encrypted data with any one of a plurality of classification items for classifying the encrypted data by inputting each of the data, which is encrypted through the data encryption step, into a deep learning-based inference model.

8. A computer-readable medium for implementing a method for classifying encrypted data using a deep learning model executed in a computing device including at least one processor and at least one memory, the computer-readable medium comprising:
computer-executable instructions for enabling the computing device to perform following steps including:
a data augmentation step of generating one or more modified data for a corresponding original data by modifying one or more original data among a plurality of original data corresponding to unstructured data;
a data encryption step of encrypting each of the plurality of original data and the one or more modified data generated through the data augmentation step using an optical-based encryption method; and
a data classification step of labeling the encrypted data with any one of a plurality of classification items for classifying the encrypted data by inputting each of the data, which is encrypted through the data encryption step, into a deep learning-based inference model.
